(19) United States
(12) Patent Application Publication
(10) Pub. No.: US 2003/0138550 A1
(43) Pub. Date: Jul. 24, 2003

(54) Method for making a fish sausage

(76) Inventor: Abdul Salaam, Philadelphia, PA (US)

Correspondence Address: ABDUL SALAAM, 208 S. 60TH STREET, PHILADELPHIA, PA, 19139, US

(21) Appl. No.: 10/051,942

(22) Filed: Jan. 22, 2002

(51) Int. Cl. A23L 1/325

(52) U.S. Cl. 426/643

(57) ABSTRACT

This is a food item that has been formulated for consumption and enjoyment by the consumer and is a taste-conscious, natural product. Its formula is unique and has proven itself through taste-tested consumption by others. Preparation of this product utilizes fresh fish and vegetables. There are no artificial additives or preservatives. Also, this product is machine-rolled and finished, with no casing on the outside.

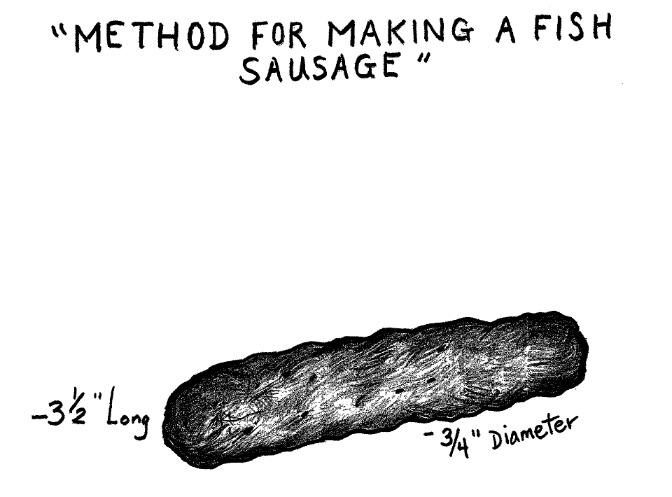

The method of preparation and construction of this item referred to as a “Fish Sausage”, is similar to a meat sausage link. There are no artificial additives or preservatives.

### DETAILED DESCRIPTION

The measurement is approximately 3½″ long by, ¾″ in diameter. The following methods are used in the creation of this invention:

Ingredients Used In Making “Fish Sausage”

Fresh Fish

White potatoes

Cracker meal

Flour

Onions

Garlic

Peppers

Celery

Vinegar

Butter

Salt

No preservatives added

Method of Preparation:

Select fish

Remove scales from fish

Remove guts from fish

Remove fins

Wash away all blood

Method of Cooking:

Boil Fish

Boil white potatoes, celery and peppers

Add garlic, onions, and red pepper

Mix with boiled vegetables, meal, flour, butter, salt and vinegar

Deep fry (for 7 minutes), cool and package

1. What I claim as my invention is “the method for making a fish sausage”, which I deem suitable for marketing and human consumption. Unique in itself, the finished product bears similarity in appearance to that of the standard beef and/or pork sausage. My product is all-natural and contains no preservatives, no additives, made with fish and formed without a casing.
